(19) United States
(12) Patent Application Publication
(10) Pub. No.: US 2016/0104100 A1
(43) Pub. Date: Apr. 14, 2016

(54) TANK BIN INVENTORY SIGNALING IN A TANK MANAGEMENT SYSTEM

(71) Applicant: George W. Ratermann, Livermore, CA (US)

(72) Inventor: George W. Ratermann, Livermore, CA (US)

(21) Appl. No.: 14/509,570

(22) Filed: Oct. 8, 2014

(51) Int. Cl. G06Q 10/08; G08B 21/18

(52) U.S. Cl. CPC G06Q 10/087; G08B 21/18

(57) ABSTRACT

A tank inventory signaling apparatus that has bins with aligned parallel rows of industrial gas cylinder tanks stored in a cage having upright posts forming fences that define storage bins. Tanks in each bin are separated from each other by hinged gates that can be closed by magnetic or electronic latches. The logic state of all latches, open or closed, is reported to a local server that communicates gate state logic to a remote server. Tank inventory is inferred by opening of gates since it is necessary to open a gate to remove a tank. All gates in a cage have a collective gate state. Changes in the gate states of all tank storage units is reported to a remote server having associated tank management and supply software and route management software. In this manner, local tank usage can be tracked at remote locations for resupply of tanks and delivery of replacement tanks can be optimized.

### TECHNICAL FIELD

The invention relates to tank cylinder inventory signaling from a storage cage in a tank management system.

### BACKGROUND ART

Industrial concerns, such as hospitals, welding shops, chemical processing plants and similar businesses, use large number of cylinders of industrial gases. Cylinders are delivered to such businesses in full condition and picked up after use. The cylinders are heavy, expensive and must be carefully stored. Methods for distribution and inventory control have been a subject of much research over the years. For example, see the paper in Interfaces 13, 6 Dec. 1983, p. 4-23 entitled “Improving the Distribution of Industrial Gages with an On-Line Computerized Routing and Scheduling Optimizer” by W. J. Bell et al. The article describes the efforts of Air Products and Chemicals, Inc. to implement industrial gas cylinder inventory management at customer locations with delivery vehicle scheduling. A sophisticated software algorithm for the project is described. An essential part of the gas cylinder management problem is knowing the present inventory of full and empty tanks. Usually a customer is responsible for inventory status and different customers have different approaches.

In U.S. Pat. No. 7,619,523 to F. Durtschi et al. describe “Gas Cylinders Monitoring by Wireless Tags”. In this system, each gas cylinder includes a RDID transponder configured to transmit a RFID signal received by a RFID receiver connected to a server. The gas cylinder data received by the server is collected in a database and thereafter used by a gas cylinder management software application. Published Patent Application 2011/0140850 describes a transport cap for gas cylinders where the cap supports RFID devices for gas cylinder tracking. A generic tank monitoring system is disclosed in U.S. Pat. No. 7,304,588 to D. Ingalsbe et al. In published U.S. Patent Application 2014/0163727 to Y. Siaamer et al. describe a gas cylinder management system where tanks are identified by optically sensing the color markings of a tank or for detecting ferromagnetic material identifiers. In U.S. Pat. No. 5,505,473 to F. Radcliffe discloses a mobile cart with shelves with radio communication of inventory on the shelves. A scanner can identify the inventory and communicates with a terminal regarding the location identifiers.

An object of the invention is to monitor use of tank cylinders at end user locations and report used tanks to a tank management cylinder system.

### SUMMARY DISCLOSURE

One of the inputs for tank management software for industrial gas cylinders comes from a tank farm where tanks are stored prior to use. The present invention contemplates a tank cage that has bins where gas cylinder tanks are stored in bins, aligning multiple tanks in rows, with tanks separated by gates that are part of a signaling system. The signaling system of a tank storage unit, i.e. a cage, reports to a local server that maintains a database of tanks in the cage. The gates separating tanks are magnetically or electromechanically latched in a releasable manner with the open and closed position of the latches designating first and second logic states. The multiple latches are networked to the local server so that an initial state of all latches can be established. As each gate is opened, for example, upon removal of a gas cylinder tank for use, the change of state of the gate array is monitored and tank movement from the bins is inferred by the gate openings. A plurality of local servers is connected via the Internet or otherwise to a remote server that is associated with tank management and supply software and route management software. The remote server tracks tank usage from the tank storage units and orders replacement tanks and optimizes delivery of replacement tanks. The remote server can display tank management information via a website or a smart phone app.

### BRIEF DESCRIPTION OF THE DRAWINGS

FIG. 1 is a perspective plan view of a tank cage in accordance with the invention.

FIG. 2 is a top plan view of a full tank cage having three parallel bins with hinged gates closed confining upright industrial gas cylinders.

FIG. 3 is a top plan view of an empty tank cage of FIG. 2 with all hinged gates open.

FIG. 4 is an electrical plan of a tank inventory signaling system in accordance with the invention.

### DETAILED DESCRIPTION

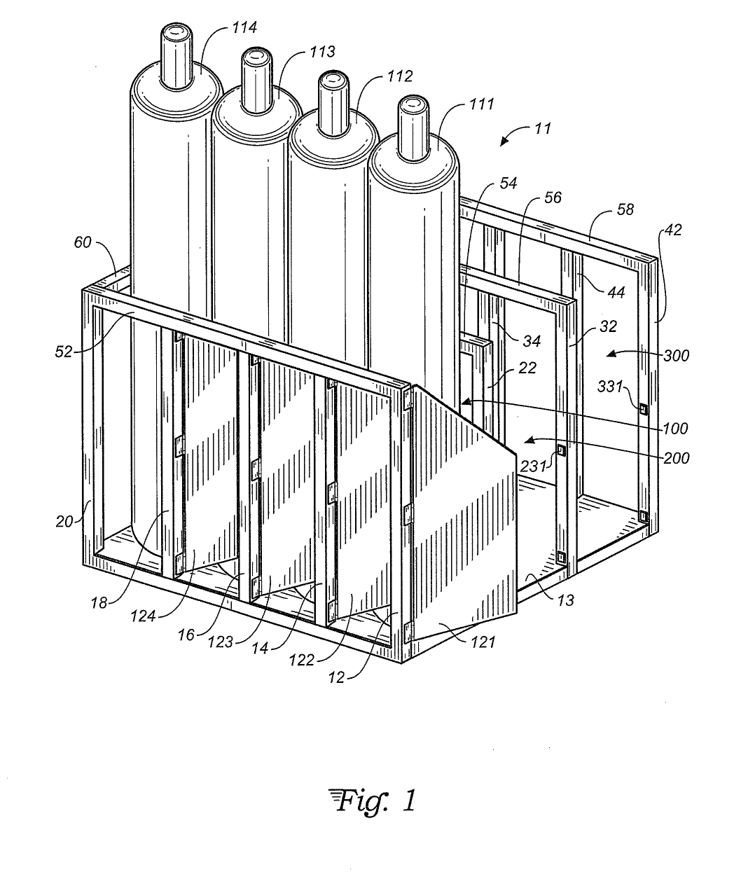

With reference to FIG. 1, a tank cage 11 is shown having a plurality of bins 100, 200, and 300. The tank cage 11 has a floor 13 and upright posts 12, 14, 16, 18, 20, 22, 32, 34, 42, 44, etc. that form parallel fences 52, 54, 56, 58, with spaced apart pairs of fences forming each bin. The fences also form the sides and back, wall 60, of the cage, with the front, opposite back 60, being open for placement and removal of gas cylinders into and out of the cage.

The width of the bin, such as bin 100 exceeds the width of a gas cylinder tank such as tanks 111, 112, 113, and 114 by a slight amount such that a series of tanks may be aligned in a bin, as shown in FIG. 1. The height of the upright posts is sufficient so that the tanks cannot tip over or be readily lifted over the posts but must be removed from the front of the cage.

Each bin, such as bin 100, has a series of movable gates, such as gates 121, 122, 123, and 124 that open and close forming tank cylinder enclosures. The gates are uniformly spaced in a bin and have a height dimension less than an upright post. Each gate is hinged on one side of the bin to open forwardly. The side of a gate opposite to a hinge has a latch. Latch 231 is shown to be associated with bin 200 and latch 331 is shown to be associated with bin 300. The latches are preferably magnetic but may be electrically or manually releasable.

When gas cylinders tanks are placed in the bins, all of the gates are opened forwardly to accommodate entry of the tanks into the bins. Then, as each tank is placed in a bin, toward the back of the bin insofar as possible, a gate is closed and latched so that the gate remains closed and spaced apart gates of a bin enclose one gas cylinder. When a bin has a requisite number of tanks in the bin, the gates should form back and forward enclosures for the tanks except for the most rearward tank which does not need a rearward gate since it is against back wall 60. When all bins are full of tanks, the cage appears to have a rectangular array of gas cylinder tanks in rows and columns.

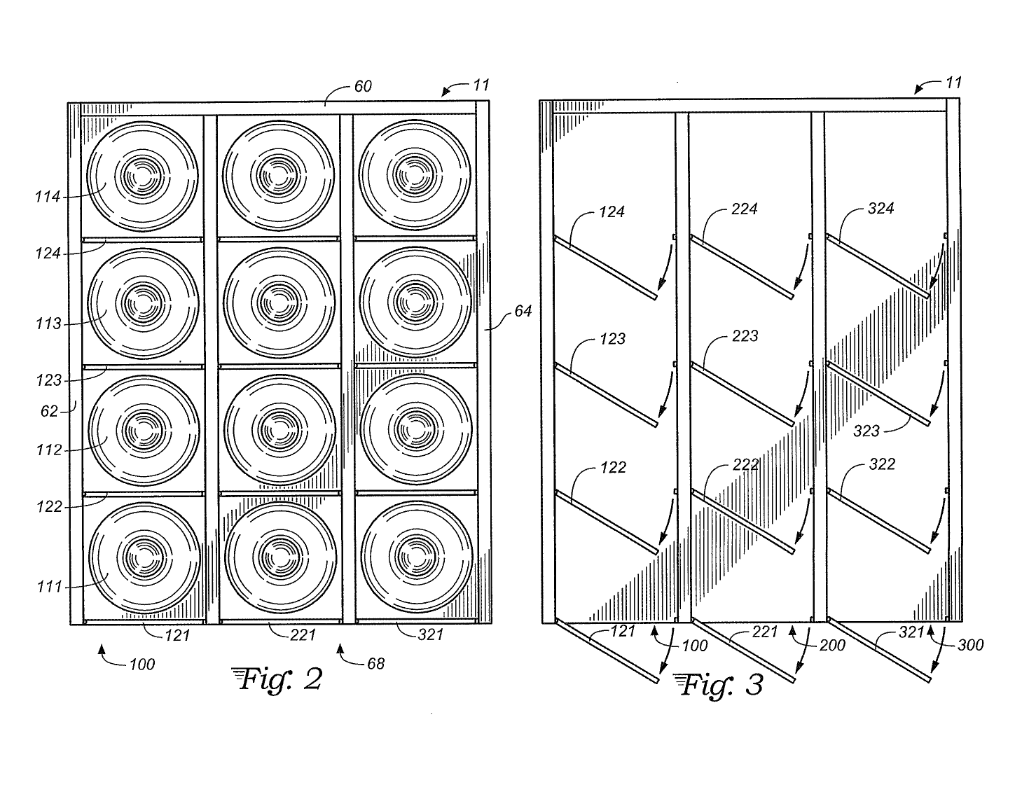

With reference to FIG. 2, the tank cage 11 is shown to have side, walls 62 and 64 with back wall 60. The front 68 of the tank cage is open when gates 121, 221, and 321 are open, but appears closed when the gates are latched. A first row of tanks 111, 112, 113, and 114 are shown to be aligned in the first bin 100 as part of a grid pattern established by closure of respective gates 121, 122, 123, and 124. The closed gate associated with each tank is at the front of each tank with the front direction being associated with the front 68 of the cage 11.

With reference to FIG. 3, the cage 11 is shown to be empty of gas cylinder tanks. The first bin 100 is shown to have open gates 121, 122, 123, and 124. The second bin 200 is shown to have open gates 221, 222, 223, and 224. The third bin 300 is shown to have open gates 321, 322, 323, and 324. For each open gate, the corresponding latch has been opened allowing removal of gas cylinder tanks from the cage. FIGS. 2 and 3 indicate respective initial and final states of gate latches that correspond to a respective full array of tanks in the cage and an empty array of tanks in the cage.

While the initial state of a cage, also called a tank storage unit, is with all gates closed, another initial state may be defined if a gate is inoperative or immaterial. In that situation, a “don't care” state for a gate may be part of the initial state. Such that gate will be ignored in future monitoring of gate state changes.

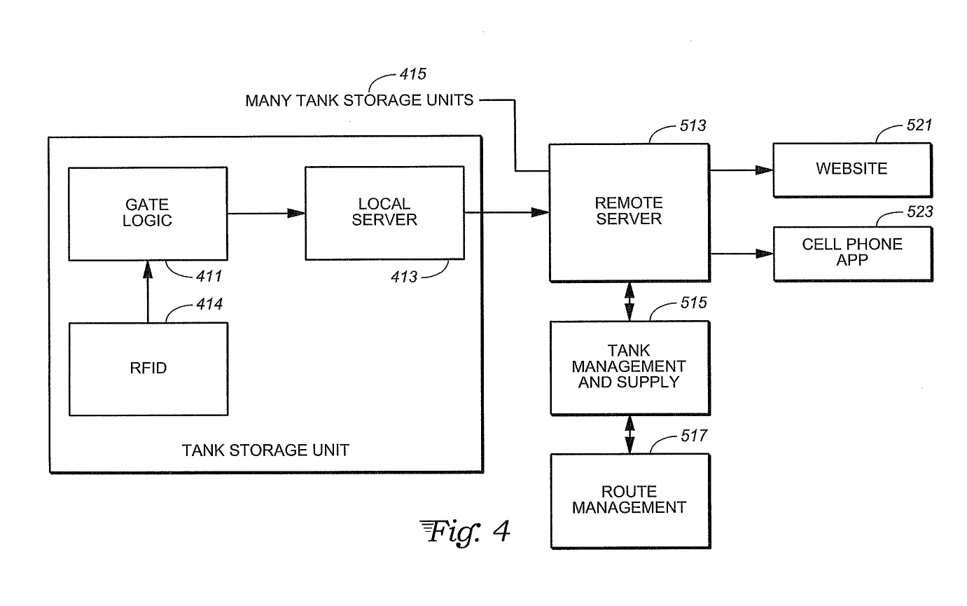

The initial state of the gates is set in gate logic 411, seen in FIG. 4. Gate logic 411 consists of memory or FPGAs that monitor changes in the initial state to the next state, and so on. When the gate is open to remove a tank, there is a gate state change monitored by a database in local server 413. Tanks can optionally be equipped with an RFID chip that can be read as a tank passes in proximity to an RFID chip reader 414 which feeds information to gate logic 411 in a manner such that a tank being removed from a bin can be identified regarding the contents of the tank. Tanks can optionally be equipped with bar code that is read by passing in front of a bar code reader. In that situation, the bar code reader would be substituted for the RFID chip reader 414.

A gate latch opening represents a change in the state of a bin array that is reported to the local server 413. Local reporting may be by a local wire network or a wireless network. The local server 413 reports the bin array gates state to a remote server 513, via the Internet or a private line. The remote server 513 tracks similar information from other tank storage units 415.

Remote server 513 has a database of tanks removed from bins based upon the bin array gate states from all connected tank storage units reporting through local servers. This database is used by tank management and supply software 515 that handles ordering, purchasing, stocking, and location of replacement tanks. In turn, the tank management supply module 515 is connected to a route management module 517 that optimizes delivery of replacement tanks. Both tank management and supply software and route management software are well known and have been described in many publications.

The remote server 513 has a video display output that can be an internet website 521 or a cell phone app 523 so that the server database can be graphically shown to users. Tank management supply software 515 and route management software 517 also communicate with the remote server for display of information through the website and the cell phone app.

In operation, if there has been no change in the initial bin array gate state from a tank storage unit, because no gates have been opened, no replacement tanks are needed for that location and such information can be displayed on a website or a cell phone app. On the other hand, if the bin array gate state from a tank storage unit shows that two gates in the same row of tanks have been opened, it is assumed that two replacement tanks of the type stored in that row are now needed. This information is conveyed by a local server to a remote server and then to the website or cell phone app. Replacement tank procurement is handled by the tank management and supply software 515 and delivery is handled by the route management software 517. All of this is facilitated by the tank cage of the present invention with bins holding gas cylinder tanks behind latched gates which communicate with gate logic as described.

What is claimed is:

1. In a tank cage having bins of a width for aligning multiple tanks in rows, a tank inventory signaling system comprising:
a movable gate separating tanks in a bin from adjacent tanks;
a releasable latch fixing each gate in a closed position, the latch associated with an indicator having a first logic state indicating the closed position and a second logic state indicating when each latch is released;
a networked local server in communication with the indicators for receiving the logic states of the latches and changes in logic states associated with opening of the gates; and
a remote server in communication with the local server having tank cylinder management software whereby tank movement in the bins detected by gate openings is monitored by the status of the logic states.

2. The apparatus of claim 1 wherein the movable gate has a magnetic latch wherein the magnetic latch is associated with a fixed magnet when the gate is in a closed position and has no association with the fixed magnet when the gate is open.

3. The apparatus of claim 1 wherein the movable gate is a hinged gate.

4. The apparatus of claim 2 wherein the state of each magnetic latch communicates with the local server wirelessly.

5. The apparatus of claim 2 wherein the state of each magnetic latch communicates with the local server by a wire network.

6. The apparatus of claim 2 wherein the local server communicates with the remote server via the internet.

7. The apparatus of claim 1 wherein the tank cage further comprises a floor with upright rails aligned in rows defining bins.

8. The apparatus of claim 7 wherein an upright rail supports each movable gate.

9. The apparatus of claim 8 wherein each movable gate has a first end hinged to an upright rail and a second end with the releasable latch.

10. The apparatus of claim 1 wherein each tank has an identifier associated with the contents of the tank.

11. The apparatus of claim 10 wherein the tank identifier is a collar.

12. The apparatus of claim 11 wherein said collar carries an RFID chip.

13. The apparatus of claim 12 further comprising an RFID chip reader in the vicinity of the tank cage wherein a change in logic states activates the RFID chip reader at a first time associated with the change in logic states and a subsequent time after the change in logic states.
